(19) United States
(12) Patent Application Publication
(10) Pub. No.: US 2004/0151189 A1
(43) Pub. Date: Aug. 5, 2004

(54) Communications device, communications method, and transmitting method

(75) Inventor: Hideki Ohkita, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/746,005

(22) Filed: Dec. 26, 2003

(30) Foreign Application Priority Data
Dec. 26, 2002 (JP) 2002-378276

(51) Int. Cl. H04L 12/56

(52) U.S. Cl. 370/400; 370/395.5

(57) ABSTRACT

A communications device includes first and second interface portions that perform communications processing according to different protocols with respect to an external device. An identification information request transmitting portion transmits an identification information request signal to the external device, requesting identification information of the external device. A table managing portion 20 creates and manages an identification information table of the external device common to the plurality of interface portions in accordance with the identification information supplied from the external device in response to the identification information request signal.

### CROSS-REFERENCE TO RELATED APPLICATION

This application is based upon, and claims the benefit of priority from the prior Japanese Patent Application No. 2002-378276, filed Dec. 26, 2002, the entire contents of which are incorporated herein by reference.

### BACKGROUND OF THE INVENTION

The present invention relates to a communications device, and more particularly to a communications device furnished with a communications function having a plurality of interfaces and to a corresponding communications method.

Along with full-scale popularization of digital devices with the recent capability of handling video information, a single digital device is now able to easily control the functions of another digital device through communications processing between the digital devices. For example, a plurality of pieces of AV (Audio Visual) equipment with a communications function can be connected to one another and perform communications processing by using an interface, such as an IEEE (Institute of Electrical and Electronics Engineers) 1394 interface and an Ethernet interface (JP-A-2000-307594)., incorporated herein by reference.

However, with more than one kind of interface for the AV equipment, each piece can be connected to different external devices. In other words, the connecting paths of a plurality of interfaces are not provided in parallel between the AV equipment and the connected-external devices. Also, because the plurality of interfaces manage a plurality of external devices independently, the same external device is not managed with the same identification information among the plurality of interfaces. The different identification information for the respective interfactes raises a problem that a single task cannot be performed by using a plurality of interfaces in a concerted manner.

### BRIEF SUMMARY OF THE INVENTION

In accordance with an aspect of the invention, a communications device includes first and second interface portions that perform communications processing according to different protocols with respect to an external device. An identification information request transmitting portion transmits an identification information request signal to the external device, requesting identification information of the external device. A table managing portion creates and manages an identification information table of the external device common to the plurality of interface portions in accordance with the identification information supplied from the external device in response to the identification information request signal.

### BRIEF DESCRIPTION OF THE SEVERAL VIEWS OF THE DRAWING

FIG. 1 is a block diagram of one example of a schematic arrangement of a communications device according to the invention.

FIG. 2 is a connection diagram showing one example of a connecting method of the communications device according to the invention.

FIG. 3A is a connection diagram showing one example of an identification result in a network when a managing table according to the invention is not used.

FIG. 3B is a connection diagram for the actual physical devices corresponding to FIG. 3A.

FIG. 4 is a connection diagram showing another example of the connecting method of the communications device according to the invention.

FIG. 5 is an explanatory view explaining one example of a connecting method of an external device and the communications device according to the invention.

FIG. 6 is a view showing one example of a manipulation screen on the communications device according to the invention.

FIG. 7 is a view showing another example of the manipulation screen on the communications device according to the invention.

FIG. 8 is a view showing one example of a control information table in the communications device according to the invention.

FIG. 9 is a view showing another example of the control information table in the communications device according to the invention.

FIG. 10 is a view used to explain communications processing between the communications device according to the invention and another communications device.

FIG. 11 is another view used to explain communications processing between the communications device according to the invention and another communications device.

FIG. 12 is still another view used to explain communications processing between the communications device according to the invention and another communications device.

FIG. 13 is a view showing one example of a commend screen on the communications device according to the invention.

FIG. 14 is still another view used to explain communications processing between the communications device according to the invention and another communications device.

FIG. 15 is a flowchart showing a process for creating a table by the communications device according to the invention.

FIGS. 16A and 16B are flowcharts showing examples of communications processing within the communications device according to the invention.

FIG. 17 is a flowchart showing another process for creating a table by the communications device according to the invention.

FIG. 18 is an example of a GUID table.

FIG. 19 is an example of an IP address table.

FIG. 20 is an example of an ID pair information table.

FIG. 21 is an example of a GUID.

FIG. 22 is an example of an IP address.

FIG. 23 is an example of a MAC address.

FIG. 24 is an example of a get ID information request command sent over a 1394 bus.

FIG. 25 is an example of identification information sent over a 1394 bus.

FIG. 26 is an example of a get ID information request command sent over the Ethernet.

FIG. 27 is an example of identification information sent over the Ethernet.

FIG. 28 shows exemplary values for the identification information of FIG. 27.

### DETAILED DESCRIPTION OF THE PREFERRED EMBODIMENTS

The following description will describe in detail embodiments with reference to the accompanying drawings.

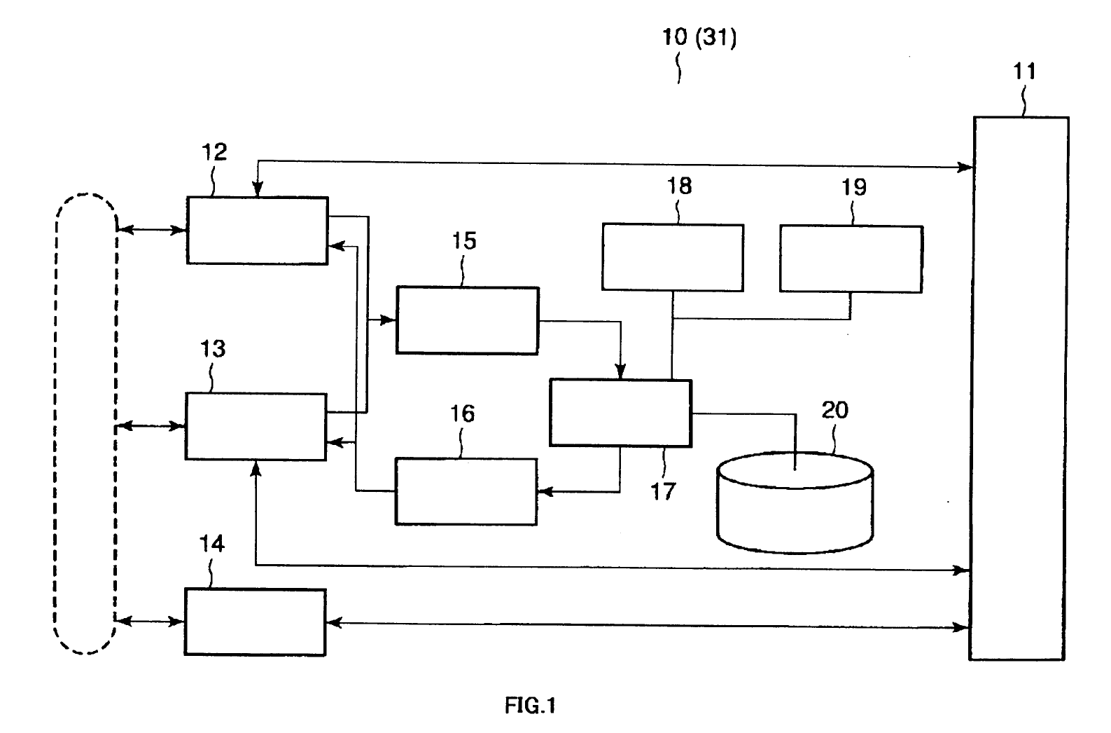

FIG. 1 is a view depicting an arrangement of a system showing one example of an embodiment of a communications device. A communications device 10(31) may be, for example, a TV device, a recorder device, or other type of AV equipment furnished with a communications function. A network is constructed by connecting one device to another through a plurality of interfaces.

As shown in FIG. 1, the communications device 10 includes a signal processing portion 11, which is provided with portions needed for its original operation. For example, if the communications device 10 (31) is a TV, the signal processing portion 11 may include a tuner portion, a decoding portion, and an AV signal processing portion. The communication device 10 (31) may also be a data processor such as a PC having a hard disk drive (HDD). The PC may be connected for controlling various devices such as a TV, recorder, etc. The communications device 10 also includes an Ethernet interface 12, which is connected to each of the foregoing portions of the signal processing portion 11, as well as to one or more external devices. The Ethernet interface is an example of a first interface. The communications device may also include an IEEE 1394 interface 13 as an example of a second interface, as well as an analog interface 14.

In addition to the above described elements, the communications device 10 further includes an identification information request transmitting/receiving portion 15, which is connected to both the Ethernet interface 12 and the IEEE 1394 interface 13, and a correspondence confirming portion 17, to which an identification information request signal is supplied from the identification information request transmitting/receiving portion 15. The correspondence confirming portion 17 confirms a correspondence of an external device to a plurality of interfaces. An identification information table is managed by a table-managing portion 20.

The communications device 10 also includes an identification information-notifying portion 16. In response to an identification information request signal given to the identification information transmitting/receiving portion 15 from an external device, the identification information transmitting/receiving portion 15 confirms whether there is a correspondence of the external device to a plurality of interfaces, and the identification information-notifying portion 16 notifies the external device of the confirmation result as identification information. Further, the communications device 10 includes a communications enabled/disabled judging portion 18 and a current settings confirming portion 19 both used to confirm the correspondence among the devices on the network.

Referring to FIG. 1, in the communications device 10 having a plurality of interfaces, such as the Ethernet LAN and the IEEE 1394, and using the LAN for a control signal and the IEEE 1394 or similar interface for transmission of high definition videos, it is possible to perform communications between the communications device 10 and an external device in parallel while fully exploiting the advantages of each interface under collective management using an identification information table described below. In other words, the communications device 10 can communicate with the external device through two different interfaces, such as the Ethernet LAN and the IEEE 1394, at the same time.

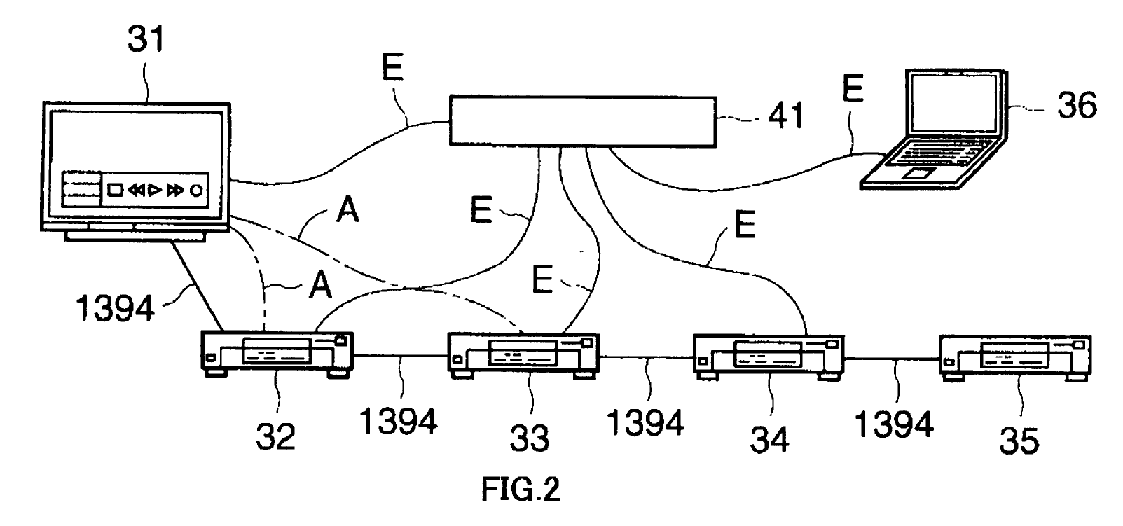

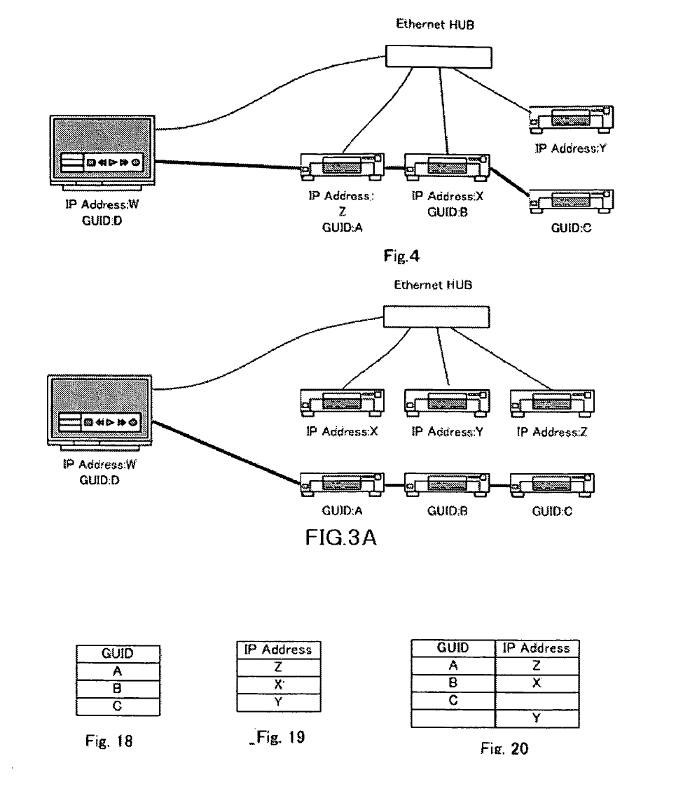

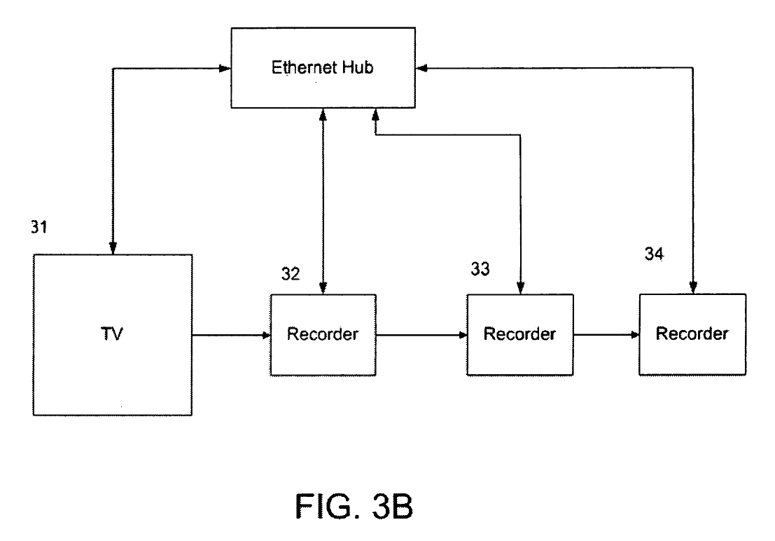

An example of a communications system constructed with the communications device will now be explained. FIG. 2 is a connection diagram showing one example of a connecting method of the communications device. FIG. 3A is a connection diagram showing one example of an identification result in a network when a managing table is not used. FIG. 4 is a connection diagram showing another example of the connecting method of the communications device. FIG. 5 is an explanatory view used to explain one example of a manipulation method of a connected-device by the communications device.

Referring to FIG. 2, as an example of a system showing a connecting method of the communications device, a TV device 31 (serving as communications device 10) is connected to recorder devices 32 through 35 each employing an HDD (Hard Disk Drive). The TV device 31 is connected to each recorder device 32 through 35 by at least one of an IEEE 1394 cable, an Ethernet cable E, and an analog cable A. Further, the TV device 31 is also connected to a notebook size PC 36 via an Ethernet hub 41 through the Ethernet cables E.

In a case where one device 31 is connected to another device 32 through connections by a plurality of interfaces, such as through the IEEE 1394 cable, the Ethernet cable E, and the analog cable A, a managing-information table is created that allows the device 31 to identify the other device 32 as a single device and as the same device on both the IEEE 1394 and the Ethernet. The managing-information table is used for the management of the devices on at least the IEEE 1394 and the Ethernet, as well as for communications processing performed between particular devices on the network.

FIG. 3A is a view showing one example of an identification result in the network when the managing table is not used. As depicted in FIG. 3A, the LAN interface sees three recorders and the IEEE 1394 interface sees three recorders, not recognizing that they are the same three recorders as seen be each interface. The actual physical layout of the three recorders is shown in FIG. 3B. Without the managing table in accordance with embodiments of the invention, the three recorders are seen as six recorders by the two different interfaces. As a result, without the managing table, it is not possible, for example, to transfer videos to a particular recorder via the IEEE 1394 in parallel with the transfer of control signals to the same particular recorder via the LAN because the IEEE 1394 interface and the LAN interface each see the “particular” recorder as a different recorder.

FIG. 4 is a view showing a network identification result in this embodiment by a control device having a plurality of interfaces. In this example, because communications device 31 can recognize a device with an IP address=X and a device with GUID=B as being the same device (recorder 33), the communications device 31 can recognize a network configuration as shown in FIG. 4. As a result, it is possible for the communications device 31 to transmit videos to an identified device via the IEEE 1394 while controlling the identified device via the LAN.

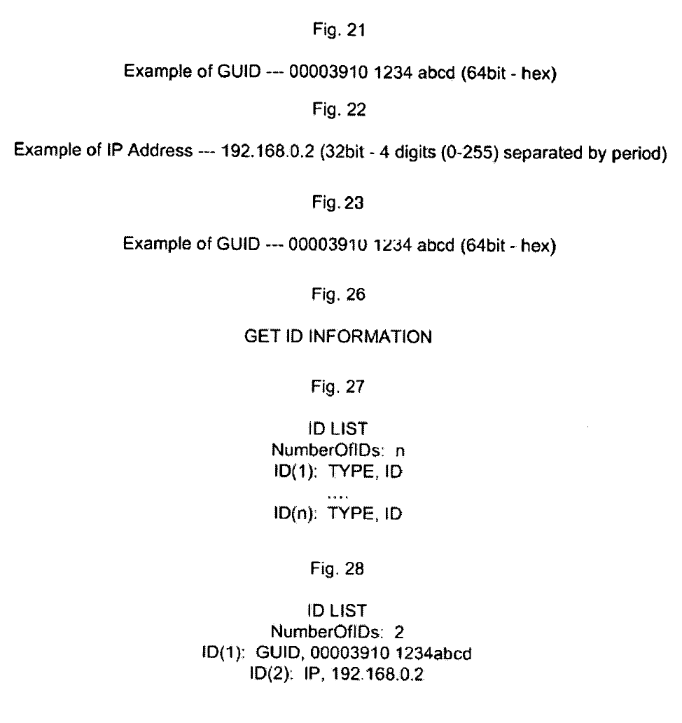

FIG. 5 is an explanatory view used to explain one example of a connecting method of the communications device and an external device. In particular, TV device 31′ can recognize that a URL 1, which is an address of a DVD manipulation panel in the LAN interface, corresponds to a sub-unit 1 in the IEEE 1394 interface by referring to an identification information correspondence table 44 which implements part of the table management portion 20 of FIG. 1. As a result, the TV device 31 is able to identify the same device in both interfaces. In other words, it is possible to manage the identification information on the LAN side 42 (IP addresses, MAC (Media Access Control) addresses, URLs, etc.) and the identification information on the IEEE 1394 side 43 (node IDs, GUIDs (Global Unique Identifier), sub-unit IDs, etc.) in the identification information correspondence table 44. FIGS. 21 to 23 show examples of a GUID, an IP address, and a MAC address, respectively. The managing table information can be transferred at a transfer request from an external device.

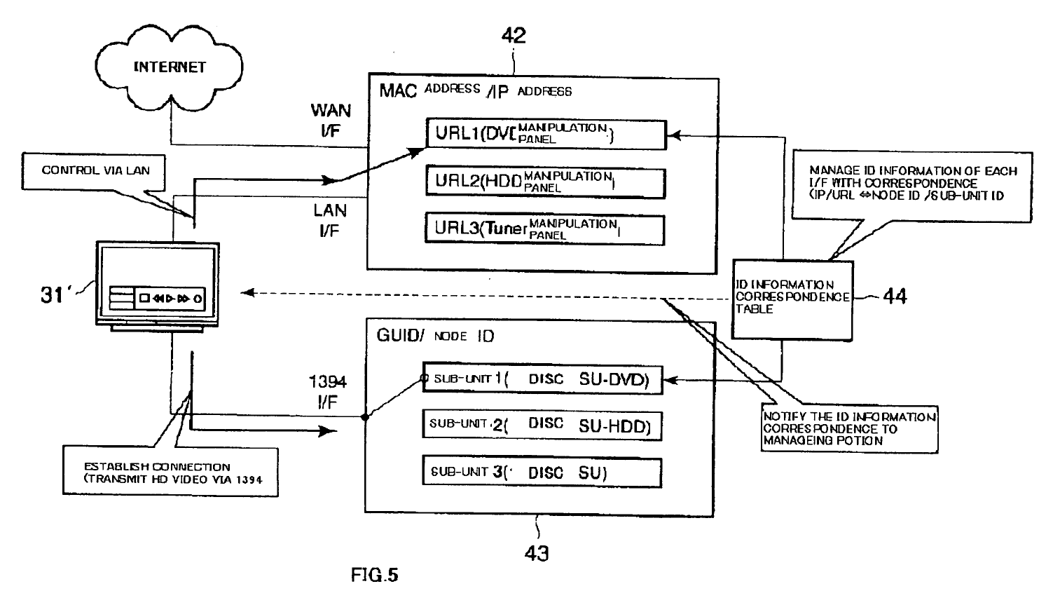

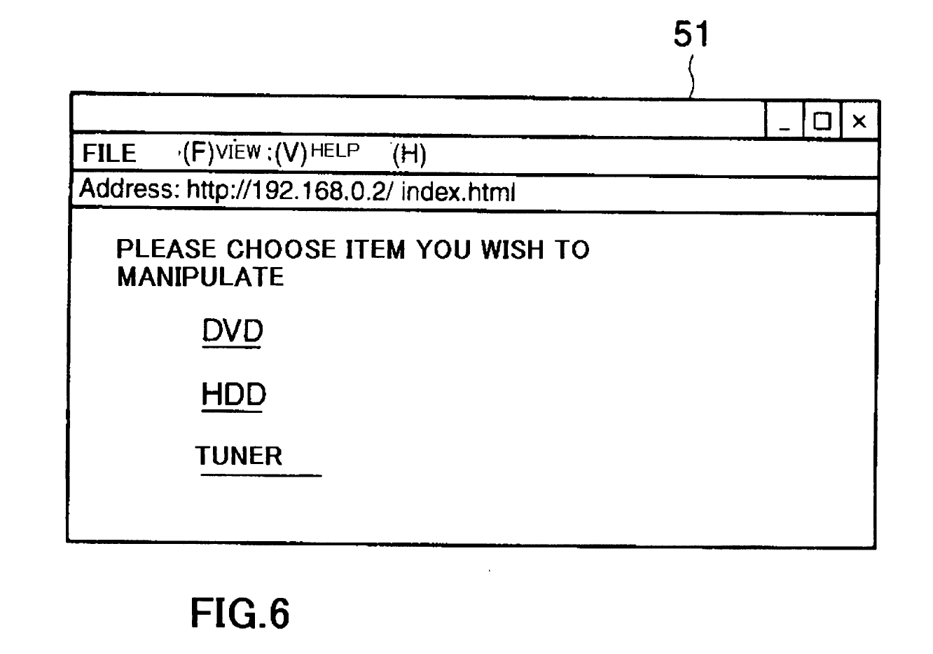

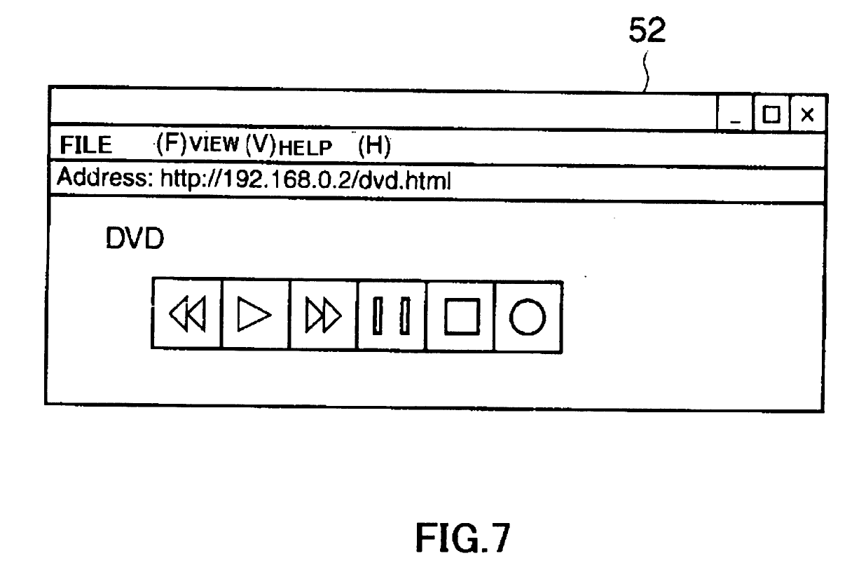

FIG. 6 is a view showing one example of a manipulation screen on the communications device. FIG. 7 is a view showing another example of the manipulation screen on the communications device.

One example of a manipulation screen will be explained as a way of using the communications function furnished to the TV device 31. A manipulation screen 51 in the browser format shown in FIG. 6 makes possible a manipulation using a plurality of interfaces, including the Ethernet interface 12 and the IEEE 1394 interface 13. As shown in the manipulation screen 51 in FIG. 6, it is possible to manipulate a DVD player, an HDD, and a tuner. By selecting, for example, the DVD player on the manipulation screen 51 shown in FIG. 6, such as through a mouse click, a manipulation icon of the DVD player is displayed on a manipulation screen 52 in the browser format of FIG. 7.

The transmitting function side can determine the optimal transmission and reception settings automatically by referring to an identification information table described in detail below. The automatic determination of transmission and reception settings can be made without input from the user identifying how a manipulation signal and the transmission and reception of a contents signal are distributed to the Ethernet interface 12 and the IEEE 1394 interface 13.

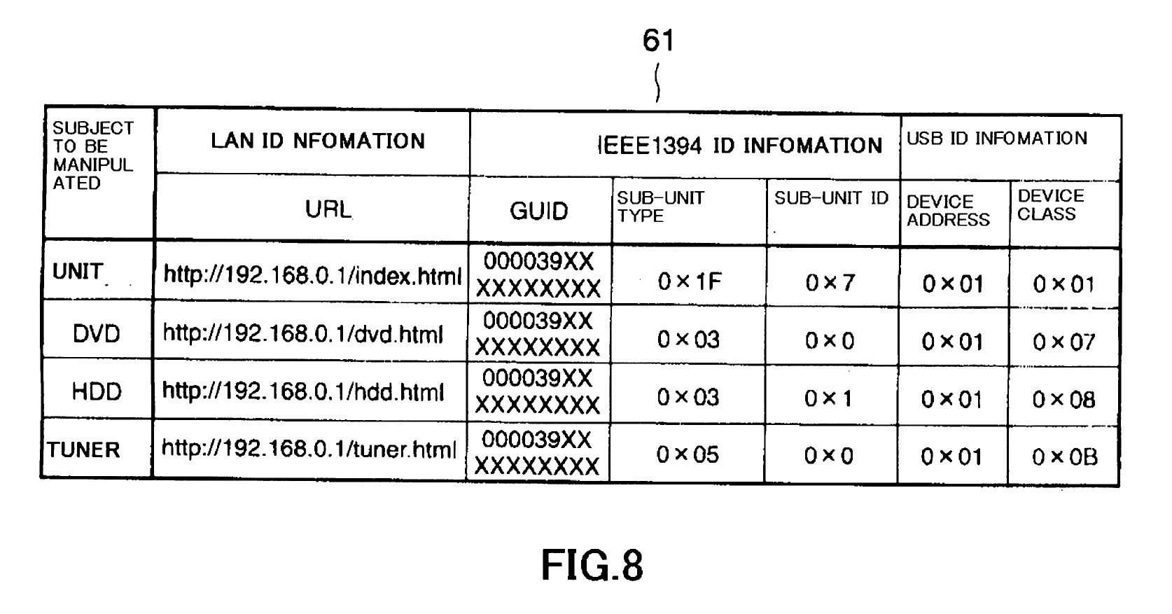

FIG. 8 is a view of the identification information table showing an example of a correspondence of identification information. The correspondence of information for various devices including a DVD player and an HDD is managed among URL information forming LAN ID information, a GUID, a sub-unit type, and a sub-unit ID forming an IEEE 1394 control unit, and a device address and a device class forming USB identification information. As described above, the identification information is not given for a single device per se, but to a function, such as a DVD, an HDD, and a tuner. Thus, each of these representative functions may be correlated to an IEEE interface address. FIG. 8 is not limited to internet applications, and other communication pathways may be used.

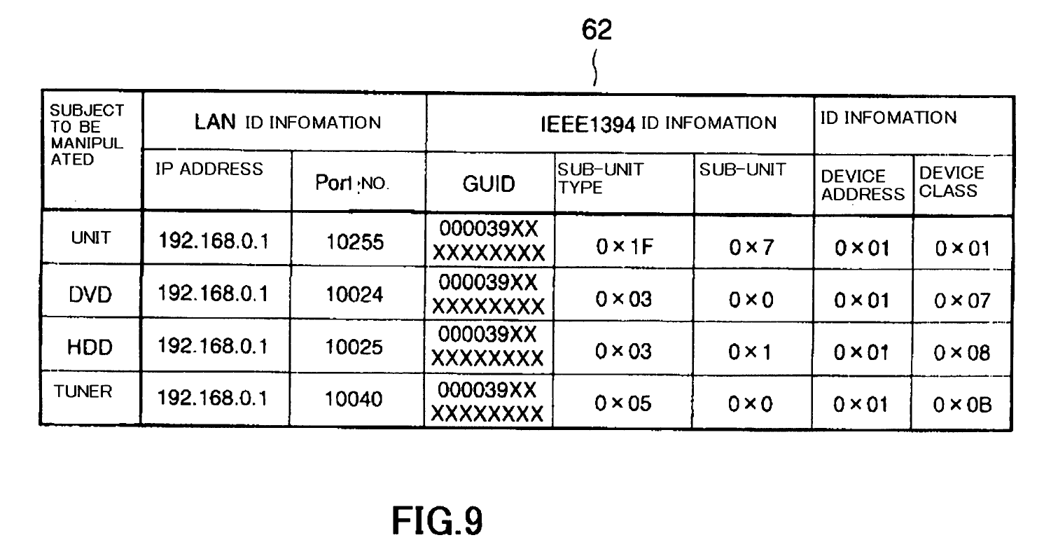

FIG. 9 is a view showing another example of a correspondence of identification information. The correspondence of information for each device is managed in the same manner as shown in FIG. 8 except for the LAN ID information. In particular, as shown in FIG. 9, the LAN ID information includes an IP address and a port number for obtaining access to each device.

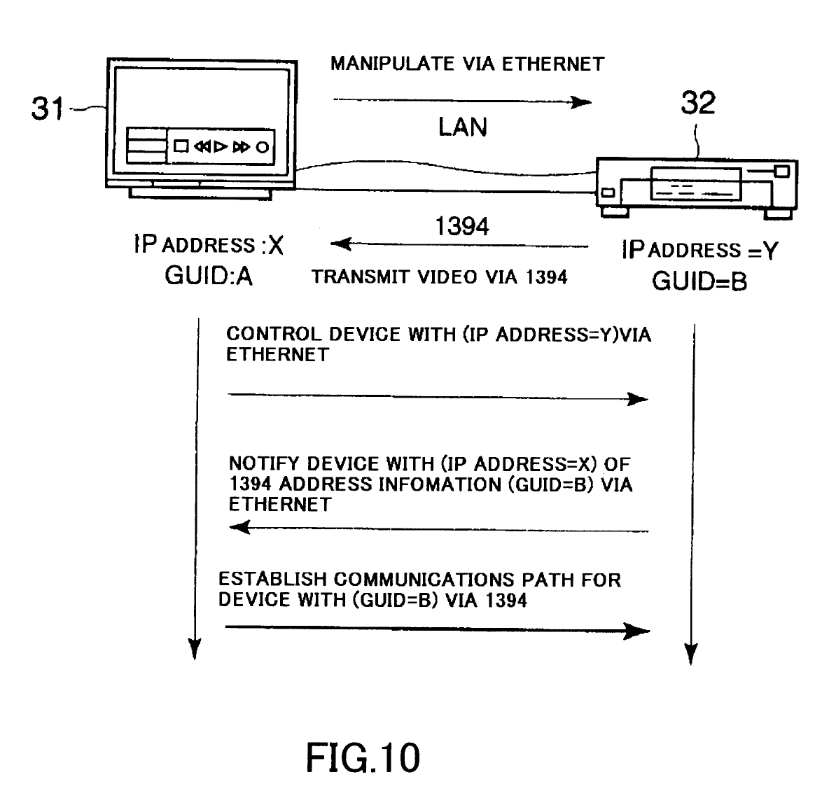

FIG. 10 is a view showing one example of a notifying method of identification information. When an access is made to the recorder device 32 via an IP address through the Ethernet, the recorder device 32 notifies the TV device 31 of its own interface information (GUID, node ID, etc.) on the IEEE 1394 side. This notification allows the TV device 31 to judge that the device with an IP address=Y and a device with GUID B is the same device. The TV device 31 is thus able to establish a connection with the IEEE 1394, which enables transmission of data, such as videos, between the TV device 31 and the IEEE 1394 interface.

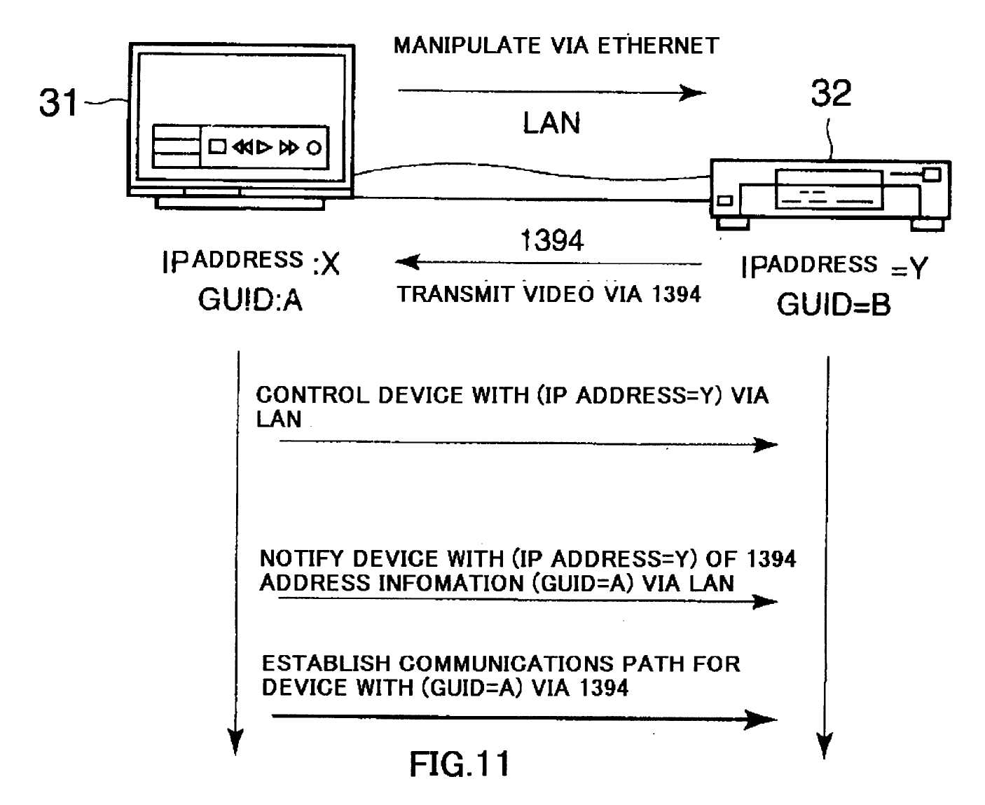

FIG. 11 is a view showing one example of another notifying method of identification information. When an access is made to the recorder device 32 via the Ethernet, the interface information (GUID, node ID, etc.) on the IEEE 1394 side for the TV device 31 is similarly notified to the recorder device 32. This notification allows the recorder device 32 to judge that the device with an IP address=X and a device with GUID=A is the same device. The recorder device 32 is thus able to establish a connection via the IEEE 1394 to the TV device 31, in addition to the connection via the Ethernet.

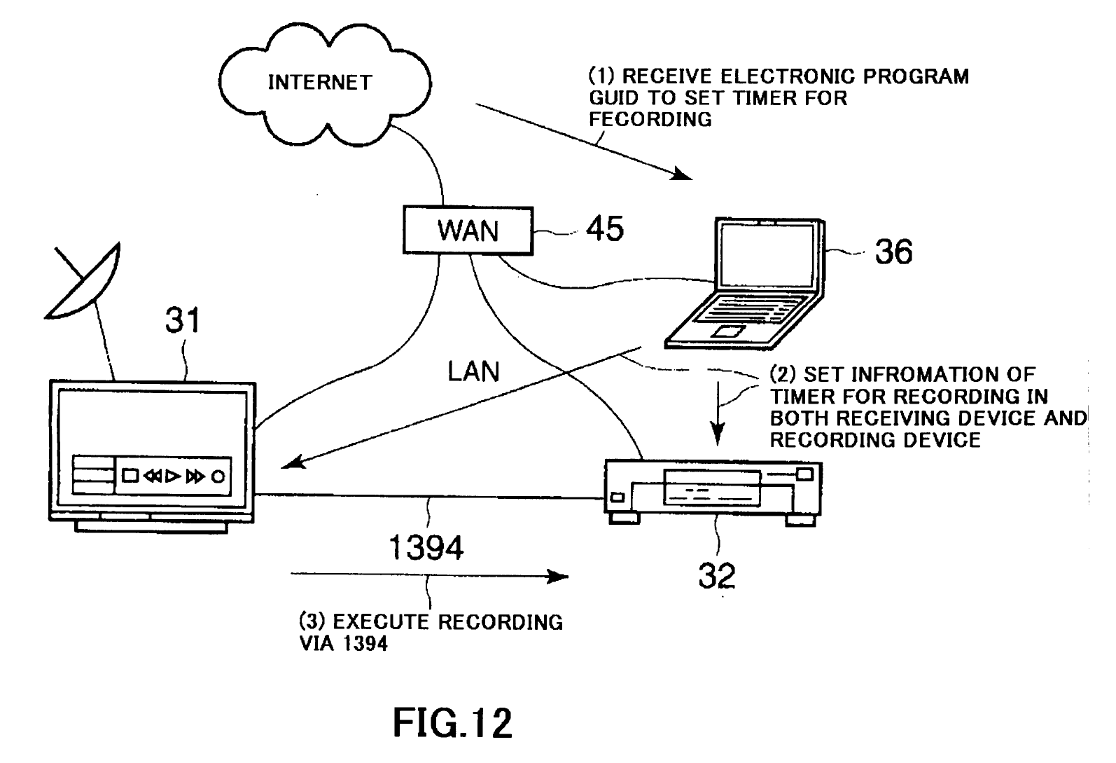

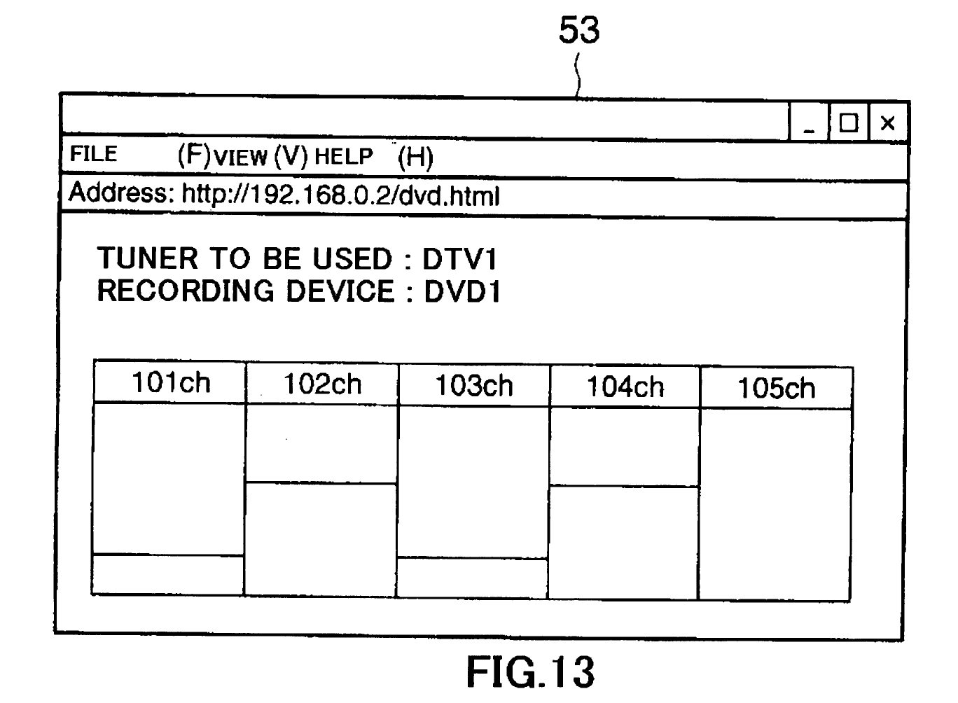

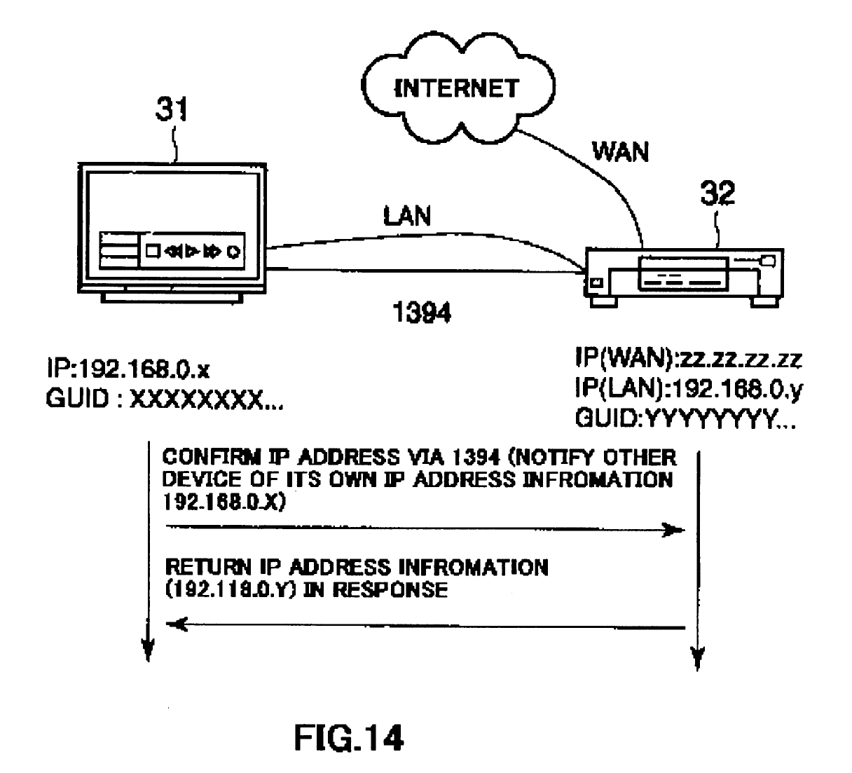

FIG. 12 is another view used to explain communications processing between the communications device and another communications device. FIG. 13 is a view showing one example of a command screen. FIG. 14 is another view used to explain communications processing between the communications device and another communications device.

As shown in FIG. 12, the communications device may be connected to a WAN 45, so that a manipulation as follows can be achieved. In this manipulation, the PC 36 obtains an electronic program guide from the Internet through the WAN 45 and sets timer information through the LAN for recording a program on the TV device 31 with the recorder device 32, and the TV device 31 instructs the recorder device 32 to execute recording via the IEEE 1394. At least two interfaces, one for the Ethernet and the other for the IEEE 1394, can be used, and processing is performed via each interface based on the identification information.

FIG. 13 is a view of a manipulation screen 53 in a browser format. The manipulation screen 53 shows a state where the TV device 31 is chosen as the tuner and the recorder device 32 is chosen as the recording device. This processing can be achieved by using the identification information table.

Further, FIG. 14 is a view showing a method of managing the managing information including IP addresses between communications devices. IP addresses are transmitted and received between the TV device 31 and the recorder device 32 through the IEEE 1394 interface.

With the foregoing manipulations, the user can make a manipulation involving transmission and reception processing to be performed through the use of an optimal interface. For example, a manipulation can be made to instruct the external recorder device 32 to perform recording processing merely by making a manipulation to the target device on the manipulation screen without the user having to perform any special manipulation of the plurality of interfaces. The distribution of control signals to the Ethernet and a contents signal to the IEEE 1394 is all done transparent to the user.

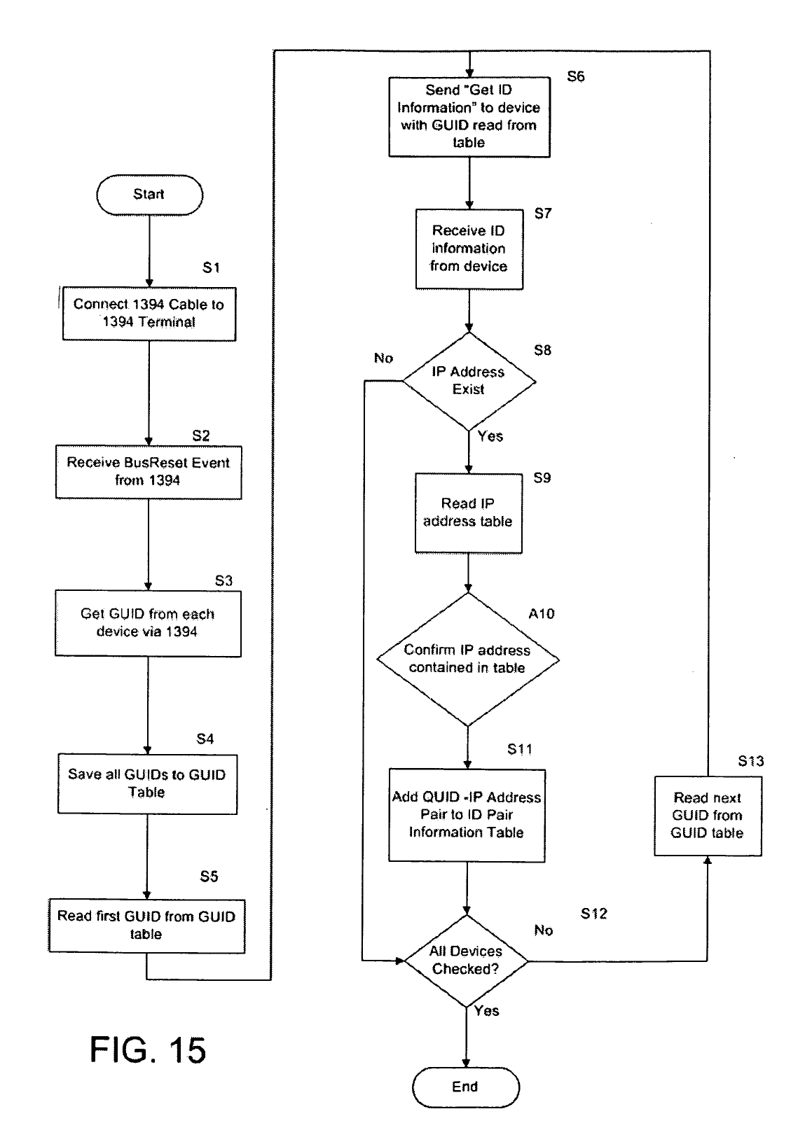

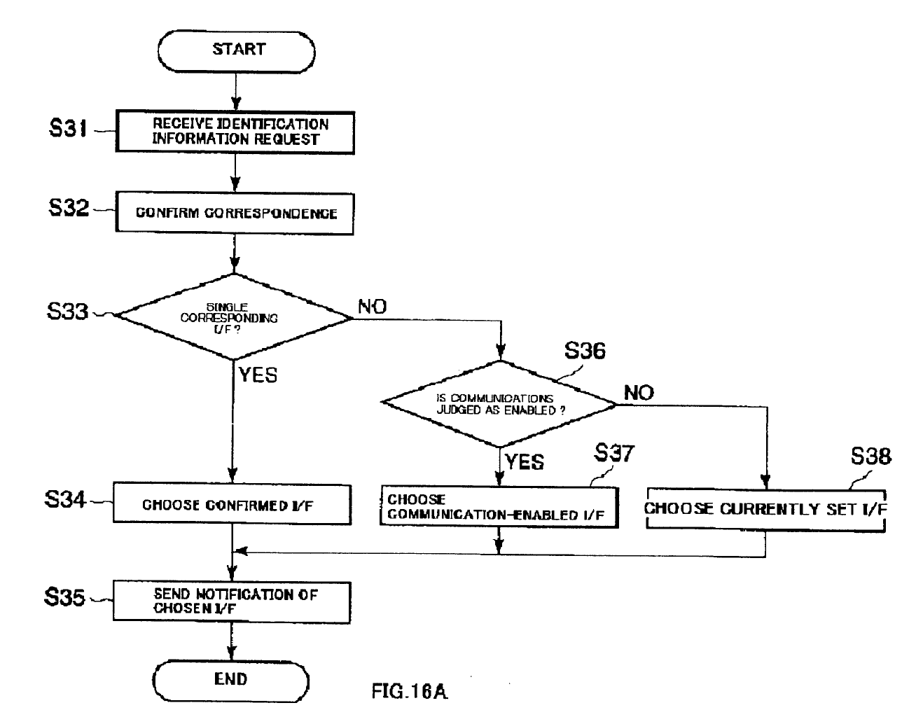

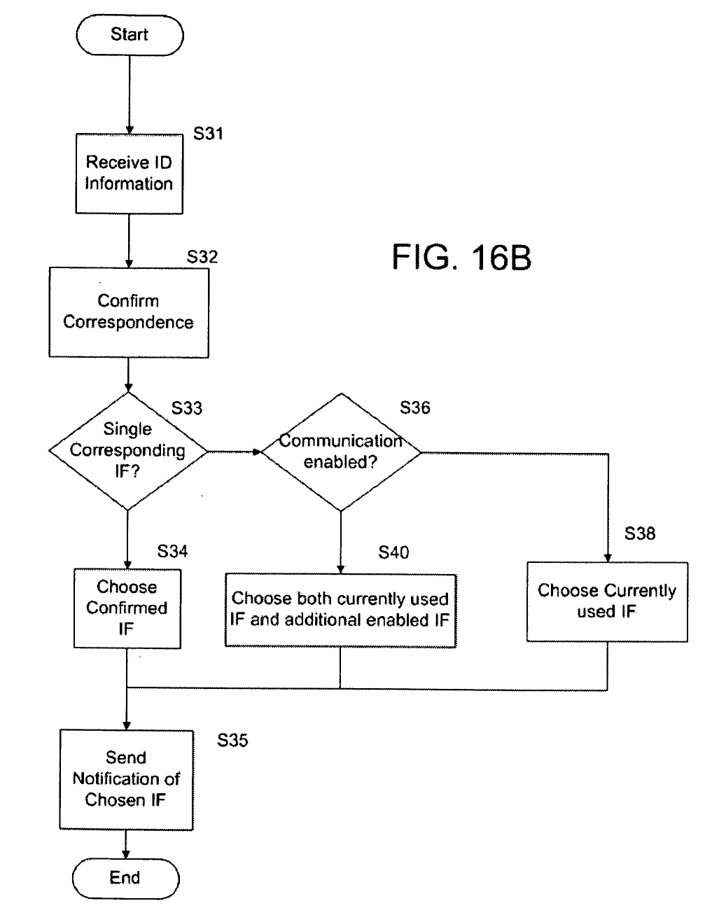

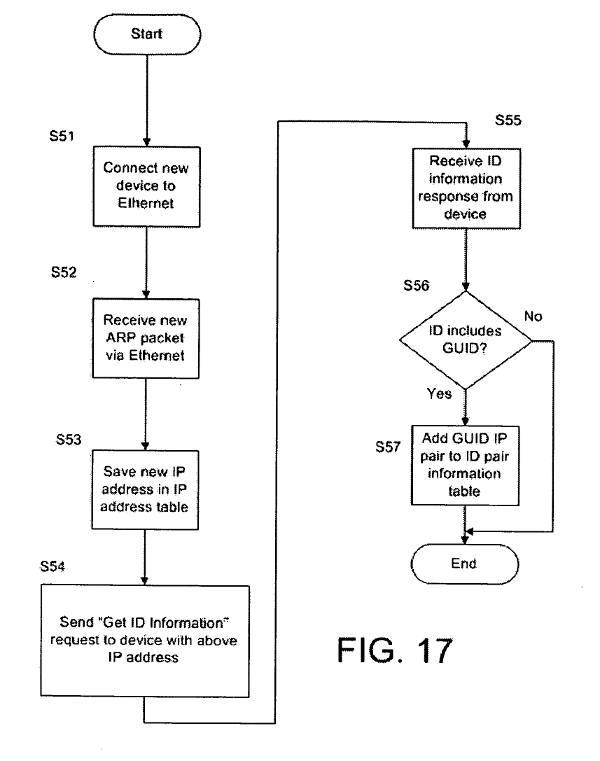

An operation of the communications device will now be explained in detail with reference to flowcharts. FIG. 15 is a flowchart showing a process for creating a table by the communications device. FIG. 16 is a flowchart showing one example of communications processing. FIG. 17 is a flowchart showing another process for creating a table by the communications device.

Referring to the flowchart of FIG. 15, a 1394 cable is first connected between the 1394 interfaces of at least two devices, such as TV device 31 and recorder device 32 (S1). The connection of a new device initiates a Receive BusReset Event on the 1394 bus (S2). The BusREset Event is transmitted and received by the ID information T/R portion 15 of FIG. 1. Receipt of the BusReset Event causes each device to on the 1394 bus to provide its GUID to each of the other devices on the 1394 bus (S3). The GUIDs of each device on the 1394 bus are then recorded in a GUID table, which is part of the ID identification information (S4). An example of a GUID table is shown in FIG. 18. The example shown in FIG. 18 corresponds to the devices having 1394 connections, as shown in FIG. 4. This table can be stored, for example, in the table managing portion 20, as shown in FIG. 1.

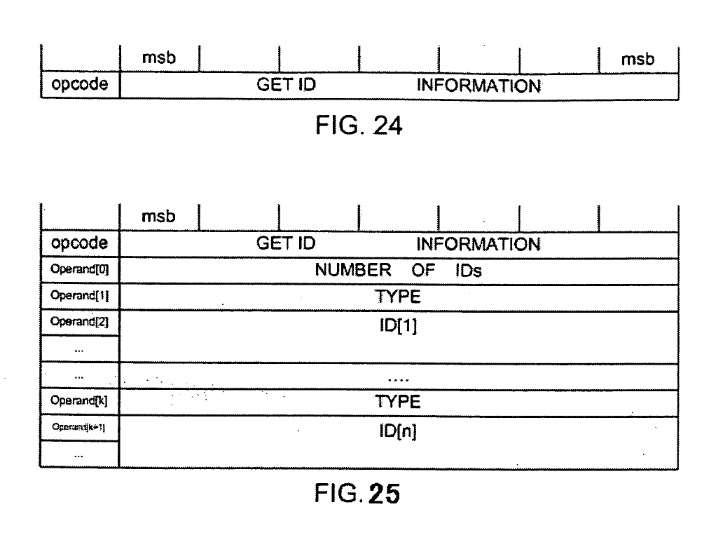

After saving all of the GUIDs in the GUID table, a first one of the GUIDs is read from the GUID table (S5). Based on this information, a “Get ID Information” request command is sent to the device with the GUID read from the GUID table (S6). An example of the get ID information request command is shown in FIG. 24.

For purposes of the following description, it is assumed that the ID information transmitting/receiving portion 15 of the TV device 31 reads the GUID from the GUID table and sends the Get ID Information request command, and that the GUID read from the table is for the recorder device 32. It should be understood, however, the transmitting/receiving portion 15 sending the ID information request command may be part of a device other than the TV device 31, and that the GUID read from the GUID table may correspond to any device on the 1394 bus.

Upon receipt of the Get ID Information request command, the recorder device 32 sends, in response, its identification information, which is received by the TV device 31 (S7). The identification information sent by the recorder device 32 includes each of the IDs assigned to the recorder device 32 for its other connections, such as the Ethernet. The Ethernet related ID preferably includes the IP address for the recorder device 32. An example of the identification information sent by the recorder device is shown in FIG. 25. The recorder device 32 may, and preferably does also send its GUID information even again, even though this information was previously provided to all IEEE interfaces on the network. The QUID information is sent again to ensure that the proper QUID of the device in question is to be associated with its corresponding IP address.

In response to the receipt of the identification information from the recorder device 32, a determination is made regarding whether or not the received identification information includes an IP address (S8). The identification information will include an IP address if the recorder device 32 (or other device sending the identification information) includes an Ethernet connection or other Internet-enabled connection.

If the identification information-includes an IP address, then an IP address table is read (S9). An example of an IP address table is shown in FIG. 19. The example shown in FIG. 19 corresponds to the devices having an Ethernet connection, as shown in FIG. 4. After reading the IP address table, the correspondence confirming portion 17 of the TV device 31 confirms whether the IP address included in the received identification information is present in the IP address table (S10). If it is not present in the IP address table, it is added to the table.

If the IP address is in the IP address table, or is newly added, then the GUID—IP address pair of the recording device 32 is added to an ID pair information table (S11). An example of the ID pair information table is shown in FIG. 20. The example shown in FIG. 20 shows the GUID—IP address pairs for the devices connected in the manner shown in FIG. 4. In FIG. 20, the interface connections of each device are listed, including the devices having only a 1394 connection or only an Ethernet connection. It is possible, however, for the ID pair information table to only show the interface connections of devices having both the 1394 and Ethernet connections. Other examples of the ID pair information tables are shown in FIGS. 8 and 9.

If the received identification information does not include an IP address or if a GUID—IP address pair has been added to the ID pair information table, then a check is made of whether or not all of the devices in the network have been checked (S12). If there are devices remaining to be checked, then the next GUID is read from the GUID table (S13). After reading the next GUID from the GUID table, steps S6 to S12 are repeated. If there are no more devices remaining to be checked, then the process ends.

According to the flowchart of FIG. 16A, the following processing takes place within the TV device 31. An identification information request signal is received from an external device, such as from recorder device 32 (S31). The identification information request signal is received by the ID information transmitting/receiving portion 15, which provides the signal to the correspondence confirming portion 17 to confirm a correspondence (S32). The correspondence confirming portion 17 makes the confirmation with reference to the table managing portion 20.

Based on the reference to the table managing portion, it is judged whether there is only one corresponding interface between the TV device 31 and the external device sending the identification information request signal (S33) when there is only one interface, the confirmed interface is chosen (S34). In addition, the external device is notified of the chosen interface (S35).

When the correspondence confirming portion 17 confirms the presence of more than one corresponding interface in S33, communications enabled/disabled judging portion 18 judges if communications is enabled or disabled (S36). Upon judgment that communications is enabled, the communications-enabled interface is chosen (S37), whereas the currently used interface is chosen upon judgment that communications is disabled (S38) The external device is then notified of the chosen interface (S35).

In the embodiment of FIG. 16A, the communication protocol was changed from the existing to another protocol provided that the other protocol was enabled. FIG. 16B is similar to FIG. 16A except that step S37 OF FIG. 16A is replaced by step S40 in FIG. 16B. In step S40, both the currently used interface and the additional enabled interface are each utilized concurrently or simultaneously. Thus, control signals may be passed along one protocol and video data along the other communication protocol.

Referring to the flowchart of FIG. 17, a new device is first connected to the Ethernet (S51). The connection of a new device to the Ethernet initiates a new ARP packet on the Ethernet, which is received by the TV device 31 (S52). The ARP packet includes the IP address, or other unique network address of the newly connected device. For matter of explanation, the following description describes the use of an IP address only. It should be understood, however, that other unique network addresses, such as a MAC address, could also be used. The IP address of the new device is then recorded in an IP address table, which is part of the identification information (S53). An example of an IP address table is shown in FIG. 19. The example shown in FIG. 19 corresponds to the devices having Ethernet connections, as shown in FIG. 4. This table can be stored, for example, in the table managing portion 20, as shown in FIG. 1.

After saving the IP address in the IP address table, a “Get ID Information” request command is sent to the newly connected device corresponding to the just-recorded IP address (S54). An example of a get ID information request command after a device is connected to the Ethernet is shown in FIG. 26.

For purposes of the following description, it is assumed that the the ID information transmitting/receiving portion 15 of the TV device 31 sends the ID information request command, and that the IP address is for the recorder device 32. It should be understood, however, the transmitting/receiving portion 15 sending the ID information request command may be part of a device other than the TV device 31, and that the IP address read from the GUID table may correspond to any device on the Ethernet.

Upon receipt of the ID information request command, the recorder device 32 sends, in response, its identification information, which is received by the TV device 31 (S55). The identification information sent by the recorder device 32 includes each of the IDs assigned to the recorder device 32 for its other connections, such as the 1394 interface. The 1394 related ID preferably includes the GUID for the recorder device 32. FIG. 27 shows an example of the identification information sent by the recorder device 32 after being connected to the Ethernet. FIG. 28 shows an example of real data that may be included in the identification information of FIG. 27.

In response to the receipt of the identification information from the recorder device 32, a determination is made regarding whether or not the received identification information includes a GUID (S56). The identification information will include a GUID if the recorder device 32 (or other device sending the identification information) includes a 1394 connection.

If the identification information includes a GUID, then the the GUID—IP address pair of the recording device 32 is added to an ID pair information table (S57). As described above, an example of the ID pair information table is shown in FIG. 20. Thus, according to the embodiment shown in FIG. 17, any newly added device may ge queried and an IP-GUID pair determined and stored on the ID pair information table.

While various embodiments described as above enable anyone skilled in the art to achieve the invention, it is easy for anyone skilled in the art to modify these embodiments in various manners, and the invention can be adapted to various embodiments even without an inventive ability. It should be appreciated therefore that the invention covers a wide scope that does not contradict the principle and novel characteristic disclosed herein, and the invention is not limited to the embodiments above.

As has been described in detail, it is possible to provide a communications device and a communications method achieving a transmission and reception manipulation using a plurality of interfaces in a concerted manner through an easy manipulation, by providing an identification information table used commonly among a plurality of interfaces in identifying individual devices on the network.

What is claimed is:

1. A communications device, comprising:
a first interface portion for performing first communications processing according to a first protocol with a device on a network;
a second interface portion for performing second communications processing according to a second protocol with said device on the network;
an identification information request transmitting portion for transmitting an identification information request signal to said device on the network and a signal requesting identification information of said device on the network through one of said first and second interface portions; and
an identification information receiving portion for receiving identification information supplied from said device on said network for identifying said device on said network for communication using the other of said first and second interfaces; and
a table managing portion for creating and managing a table of the identification information of said device on the network in accordance with the identification information received by said identification information receiving portion from said device on the network in response to said identification information request signal
wherein said device on said network is recognized as the same device by said communication device.

2. The communications device according to claim 1, further comprising:
an identification information notifying portion for generating, upon receipt of a second identification information request signal from a second device on the network, an identification information signal of said communications device and notifying said second device of said identification information signal through one of said first and second interface portions.

3. The communications device according to claim 1, wherein:
said table managing portion transmits information to and receives information from said device on the network through at least one of said first and second interface portions based on said table of the identification information of said device.

4. The communications device according to claim 1, wherein:
at least one of said first and second protocols is an Ethernet protocol.

5. The communications device according to claim 1, wherein:
at least one of said first and second protocols is an IEEE (Institute of Electrical and Electronics Engineers) 1394 protocol.

6. The communications device according to claim 1, wherein:
at least one of said first and second protocols is a USB (Universal Serial Bus) protocol.

7. The communications device according claim 1, wherein:
said table managing portion transmits at least a portion of said table of the identification information in response to a transfer request signal requested from said device on the network.

8. The communications device according to claim 1, wherein:
said table managing potion manages the identification information of said device as one function or each of multiple functions contained in said device on the network.

9. The communications device according to claim 1, further comprising:
an identification information notifying portion for notifying said device of the network as to a kind of interface available for said communications device through one of said first and second interface portions, together with identification information of said communications device.

10. A communications method between a communications device and a device on a network, said communications device being provided with first and second interface portions for performing communications processing according to different protocols with said device, said method comprising:
transmitting an identification information request signal, requesting identification information of said device, from said communications device to said device on the network through one of said first and second interface portions;
receiving identification information from said device on the network in response to said transmitted identification information request signal; and
creating and managing a table of the identification information of said device on said network which is commonly accessible to said first and second interface portions on the communications device in accordance with the identification information supplied from said device on the network in response to said identification information request signal.

11. The communications method according to claim 10, further comprising:
notifying a second device with an identification information signal of said communications device through one of said first and second interface potions upon receipt of a second identification information request signal from said second device on the network.

12. The communications method according to claim 10, further comprising:
transmitting and receiving information between said communications device and said device on the network through at least one of said first and second interface portions., based on said table of the identification information of said device.

13. The communications method according to claim 10, wherein:
at least one of said first and second interface portions has an interface conforming to an Ethernet protocol.

14. The communications method according to claim 10, wherein:
at least one of said first and second interface portions has an interface conforming to an IEEE (Institute of Electrical and Electronics Engineers) 1394 protocol.

15. The communications method according to claim 10, wherein:
at least one of said first and second interface portions has an interface conforming to a USB (Universal Serial Bus) protocol.

16. The communications method according claim 10, further comparing:
transmitting said table of the identification information to said device on the network in response to a transfer request signal from said device on the network.

17. The communications method according to claim 10, wherein:
the identification information of said device has one function or each of multiple functions contained in said device on the network.

18. The communications method according to claim 10, further comprising:
notifying said device of information as to a kind of interface available for said communications device through one of said first and second interface portions, together with identification information of said communications device.

19. A communications device, comprising:
a first interface portion for performing communications processing according to a first protocol with at first device on a network;
a second interface portion for performing communications processing according to a second protocol, different from the first protocol, with said first device on the network;
an identification information request transmitting portion for transmitting an identification information request signal using one of said first and second protocols through a corresponding one of said first and second interface portions to the first device on the network, said identification information request signal requesting identification information from said first device; and
an identification information request receiving portion for receiving said identification information from said first device, said identification information including a first identifier for said first device corresponding to the other of said first and second protocols, said first identifier specifying the identity of said first device with respect to said other of said first and second protocols.

20. The communications device according to claim 19, further comprising:
a table managing portion for creating and managing a first table that associates the first device with the first identifier and with a second identifier identifying said first device with one of said first and second protocols.

21. The communications device according to claim 20, wherein said table managing portion is further configured to create and manage a second table that associates each of a plurality of devices on the network having an interface conforming with the first protocol with a respective identifier, and a third table that associates each of said plurality of devices on the network having an interface conforming with the second protocol with a respective identifier.

22. The communications device according to claim 19, wherein one of said first and second protocols is an Ethernet protocol.

23. The communications device according to claim 19, wherein one of said first and second protocols is an IEEE (Institute of Electrical and Electronics Engineers) 1394 protocol.

24. The communications device according to claim 19, wherein one of said first and second protocols is a USB (Universal Serial Bus) protocol.

25. The communications device according to claim 19, wherein the communications device transmits a first type of data to said first device through the first interface portion, and transmits a second type of data, different from the first type of data, to said first device through the second interface portion.

26. The communications device according to claim 25, wherein the first type of data includes control signals, and the second type of data includes video data.

27. The communications device according to claim 26, wherein the first protocol is an Ethernet protocol, and the second protocol is an IEEE (Institute of Electrical and Electronics Engineers) 1394 protocol.

28. The communications device according to claim 19, wherein the identification information request transmitting portion transmits an identification information request signal through one of said first and second interface portions to a second device on the network, and
wherein the identification information request receiving portion receives said identification information from said second device, said identification information from said second device including a first identifier for said second device corresponding to the other of said first and second protocols.

29. A communications device according to claim 28, further comprising a table managing portion for creating and managing a first table that associates the first device with the first identifier and with a second identifier identifying said first device with one of said first and second protocols wherein the table managing portion modifies the first table to associate the second device with the first identifier of the second device and with a second identifier identifying said second device with said one of said first and second protocols.

30. A communications method between a communications device and at least one device on a network, said communications device being provided with first and second interface portions for performing communications processing corresponding to first and second protocols, respectively, with said at least one device, said method comprising:
transmitting an identification information request signal using a first identifier and using one of said first and second protocols through a corresponding one of said first and second interface portions to a first device on the network, said identification information request signal requesting identification information from said first device; and
receiving said identification information from said first device, said identification information including a second identifier for said first device corresponding to an interface conforming to the other of said first and second protocols.

31. The communications method according to claim 30, further comprising:
creating a first table that associates the first device with the first identifier and the second identifier.

32. The communications method according to claim 31, further comprising:
creating a second table that associates each of said at least, one device on the network having an interface conforming with the first protocol with a respective identifier; and
creating a third table that associates each of said at least one device on the network having an interface conforming with the second protocol with a respective identifier.

33. The communications method according to claim 30, wherein one of said first and second protocols is an Ethernet protocol.

34. The communications method according to claim 30, wherein one of said first and second protocols is an IEEE (Institute of Electrical and Electronics Engineers) 1394 protocol.

35. The communications method according to claim 30, wherein one of said first and second protocols is a USB (Universal Serial Bus) protocol.

36. The communications method according to claim 30, further comprising:
transmitting a first type of data to said first device through the first interface portion; and
transmitting a second type of data, different from the first type of data, to said first device through the second interface portion.

37. The communications method according to claim 36, wherein the first type of data includes control signals, and the second type of data includes video data.

38. The communications method according to claim 37, wherein the first protocol is an Ethernet protocol, and the second protocol is an IEEE (Institute of Electrical and Electronics Engineers) 1394 protocol.

39. The communications method according to claim 30, further comprising:
transmitting an identification information request signal using a first identifier of said second device and one of said first and second protocols through a corresponding one of said first and second interface portions to a second device on the network; and
receiving said identification information from said second device, said identification information from said second device including a second identifier for said second device corresponding to the other of said first and second protocols.

40. A communications method according to claim 39, further comprising:
modifying the first table to associate the second device with the first identifier of the second device and the second identifier of the second device.
